(19) United States
(12) Patent Application Publication
(10) Pub. No.: US 2017/0371057 A1
(43) Pub. Date: Dec. 28, 2017

(54) METHOD OF AND SYSTEM FOR CREATING A SEISMIC PROFILE

(71) Applicant: SHELL OIL COMPANY, Houston, TX (US)

(72) Inventors: Albena Alexandrova MATEEVA, Houston, TX (US); Peter Berkeley WILLS, Houston, TX (US); Jorge Luis LOPEZ, Bellaire, TX (US); Johan Cornelis HORNMAN, Rijswijk (NL)

(21) Appl. No.: 15/538,125

(22) PCT Filed: Dec. 22, 2015
(86) PCT No.: PCT/US2015/067270

§ 371 Date: Jun. 20, 2017

Related U.S. Application Data
(60) Provisional application No. 62/095,848, filed on Dec. 23, 2014.

(51) Int. Cl. G01V 1/42; G01V 1/02

(52) U.S. Cl. CPC G01V 1/42; G01V 1/02; G01V 2210/1299

(57) ABSTRACT

A seismic source (50) is buried in a multi-layered subsurface formation below a fast layer (30) and above a reflecting interface (10). The seismic source (50) excites a critically refracted (CR) wave that travels laterally along a fast layer bottom interface (35), and emanates downwardly into a slow layer (40) that is below and adjacent to the fast layer (30). One or more receivers (60), positioned below the fast layer (30) and above the reflecting interface (10) are used to detect seismic waves (84, 86). The one or more receivers (60) are positioned within a borehole (65). At least one reflected CR wave is isolated from the received signals, which is a CR wave that has reflected off of the reflecting layer (10) below the one or more receivers (60). A seismic profile of the multi-layered subsurface formation is created, using the at least one reflected CR wave. Time-lapse seismic monitoring of hydrocarbon extraction operations, such as steam injection, is also provided.

### FIELD OF THE INVENTION

The present invention relates to a method of and a system for creating a seismic profile of a multi-layered subsurface formation below an earth surface comprising a reservoir rock layer covered by an overburden.

### BACKGROUND OF THE INVENTION

Gas and oil reservoirs usually can be found beneath an overburden, which generally includes a set of high and low velocity contacting layers. Reservoir surveillance during production is a key to meeting goals of reduced operating costs and maximized recovery. Time-lapse seismic methods are well known method for monitoring changes in the reservoir during production. Seismic velocity and density changes in a producing reservoir depend on rock type, fluid properties, and the depletion mechanism. Time-lapse seismic responses may be caused by changes in reservoir saturation, pore fluid pressure, changes during fluid injection or depletion, fractures, and temperature changes.

Enhanced oil recovery (EOR) is a general term used for increasing the amount of oil that can be extracted from a reservoir. EOR techniques include but are not limited to gas injection, thermal recovery (e.g. steam injection or steam flooding), and chemical injection. Areal field monitoring of EOR processes and other reservoir events has proven very successful as an aid to understanding the sometimes complex behavior of producing reservoirs. Seismic and other monitoring methods such as passive microseismic monitoring, satellite imagery and material balance calculations can all contribute to an integrated understanding of the reservoir changes.

A variety of techniques is known and used in the art for seismic profiling. One such technique is so-called offset vertical seismic profiling (offset VSP) as summarized in for example Chapter 6 of TUD university B.Sc. course “Introduction to Reflection Seismology” by G. G. Drijkoningen (2011), wherein typically a plurality of geophones is arranged in a borehole as the receiver, and one seismic source is located at the surface laterally displaced relative to the geophones (offset). Recently it has been proposed to employ a fiber optic distributed acoustic sensing (DAS) cable in lieu of the geophones. The geophones or the fiber optic DAS cable typically record direct seismic waves transmitted from the seismic source and reflected direct waves that have reflected from an interface of neighboring subsurface layers.

Particularly for larger offsets a very strong seismic source is necessary.

### SUMMARY OF THE INVENTION

In accordance with a first aspect of the present invention, there is provided a method of creating a seismic profile of a multi-layered subsurface formation below an earth surface, said subsurface formation comprising a reservoir rock layer covered by an overburden that comprises a slow layer covered by a fast layer, wherein the slow layer is adjacent to the fast layer and separated from the fast layer by a fast layer bottom interface, said method comprising steps:

a) providing a set of signals obtained by:
transmitting a seismic wave from a seismic source that is positioned below the fast layer bottom interface;
receiving an original set of signals emanating from the multi-layered subsurface formation in response to the seismic wave with one or more receivers arranged within a borehole spatially distributed along a length of the borehole, wherein the one or more receivers are located below the fast layer, whereby said original set of signals comprises received signals;
   b) isolating from the received signals at least one reflected critically refracted wave that has traveled along the fast layer bottom interface as a critically refracted (CR) wave, emanated downwardly into the slow layer as a downwardly emanated CR wave, and reflected off of a reflecting interface that is located below the one or more receivers; and
   c) creating a seismic profile of the multi-layered subsurface formation using the at least one reflected CR wave.

The method may further include a step d) of outputting the seismic profile to an output device. The seismic profile may be created in the form of a seismic image of the multi-layered subsurface formation and/or an event attribute.

In accordance with a second aspect of the invention, there is provided a system for creating a seismic profile of a multi-layered subsurface formation below an earth surface, said subsurface formation comprising a reservoir rock layer covered by an overburden that comprises a slow layer covered by a fast layer, wherein the slow layer is adjacent to the fast layer and separated from the fast layer by a fast layer bottom interface, said system comprising:
a seismic source that is positioned below the fast layer bottom interface;
one or more receivers located below the fast layer and arranged within a borehole spatially distributed along a length of the borehole;
an receiver interface unit arranged at the surface and in communication with the one or more receivers to collect and process signals from the one or more receivers; and
a computer device for creating a seismic profile of the multi-layered subsurface formation using at least one reflected critically refracted wave that has been isolated from the signals.

The reservoir rock layer in the above summarized aspects of the invention may, for example, be a hydrocarbon reservoir rock layer.

### BRIEF DESCRIPTION OF THE DRAWING

FIG. 1 shows a schematic cross sectional view of a multi-layered subsurface formation in which a first embodiment of the method and system of the present invention is illustrated;

FIG. 2 shows a schematic cross sectional view of a multi-layered subsurface formation in which a second embodiment of the method and system of the present invention is illustrated; and

FIG. 3 shows a schematic cross sectional view of a multi-layered subsurface formation in which a third embodiment of the method and system of the present invention is illustrated.

These figures are not to scale.

### DETAILED DESCRIPTION OF THE INVENTION

The invention will be further illustrated hereinafter by way of example only, and with reference to the non-limiting drawing.

For the purpose of this description, identical reference numbers used in different figures refer to similar components. The person skilled in the art will readily understand that, while the invention is illustrated making reference to one or more a specific combinations of features and measures, many of those features and measures are functionally independent from other features and measures such that they can be equally or similarly applied independently in other embodiments or combinations.

In the description and claims, the terms “fast” and “slow” are used as relative terms with respect to each other whereby “fast layer” and “slow layer” both refer to formation layers in the overburden, whereby the fast layer” possesses a higher seismic velocity than the “slow layer”. For example, the fast layer may have a seismic velocity of (about) 3000 m/s or higher and/or the slow layer may have a seismic velocity of (about) 2500 m/s or lower.

The term “critically refracted wave” (CR wave) is used to describe a seismic wave that travels along the fast layer bottom interface before being emanated into the slow layer below the fast layer bottom interface. CR waves may also be referred to as head waves or refracted waves.

The term “reflected critically refracted wave” is used to describe a CR wave that has emanated downwardly into the slow layer has subsequently been reflected off of a geological reflecting interface, such an interface formed by a geological layer within or below the overburden. In this context, reflected waves are considered to include total internal reflections (critically reflected waves).

The term “target layer” is used to describe any specific layer within the multi-layered subsurface formation that is specifically being studied. Depending on circumstances, this may for instance be the containing reservoir rock layer, or a cap layer on top of the containing reservoir rock layer, or it may for instance be a salt layer in the overburden above the containing reservoir rock layer. The reservoir rock layer may suitably be a hydrocarbon reservoir rock layer. Hydrocarbon reservoir rock layers are important geological features, not only as a source of mineral hydrocarbons, but also having potential for underground storage of substances, including for instance natural gas and CO₂.

The interface between the target layer and an adjacent formation layer either directly above or directly below target layer is referred to herein by the term “target interface”. Reflected CR waves that have reflected off of the target interface may hereinafter be referred to as “target reflected CR waves” or simply “CR target reflections”, to distinguish them from CR waves that may have reflected off of other layers in the overburden below the fast layer. However, target attributes may also be inferred from CR reflections that are not CR target reflections.

The term “critical angle” is used to describe an angle of an incident seismic wave relative to the normal direction perpendicular to the fast layer bottom interface at which the angle of the wave transmitted from the slow layer into the fast layer is perpendicular to the normal direction.

The presently proposed method and system can be used to create a seismic profile of a multi-layered subsurface formation that includes a reservoir rock layer covered by an overburden which comprises a slow layer and a fast layer which is adjacent to and covers the slow layer. The fast layer is somewhere in the overburden between the earth surface and the reservoir rock layer. Frequently found fast layers in the overburden include a salt layer or a layer of carbonates.

The invention employs a seismic source that is positioned below the fast layer bottom interface. The seismic source excites a CR wave that travels laterally along the bottom of the fast layer at the interface with the slow layer, and emanates downwardly into the slow layer. The seismic source may be positioned within the slow layer. The seismic source is preferably within the slow layer and not too far removed from the interface (e.g. within at most 80 m from the fast layer bottom interface), as the efficiency of exciting the CR waves is expected to go down if the source is too far removed from the interface.

In addition, one or more receivers are employed which are arranged within a borehole and below the fast layer. At least one reflected CR wave is isolated from the received signals. Such reflected CR wave is a CR wave that has that has reflected off of a reflecting interface located below the fast layer bottom interface and below the one or more receivers. Preferably, the reflected CR wave is an up-going wave.

Isolating reflected CR waves has a number of advantages. Firstly, a relatively weak source can be employed compared to a relatively large offset, as the CR waves contributing to the signal traverse part of the lateral distance between the seismic source and the one or more receivers in two dimensions rather than in three. Moreover, the fast layer is not blocking the one or more receivers from the seismic source. Therefore, instead of being a disadvantage by disturbing and reflecting the seismic waves back to the surface and weakening the signals of interest, the fast layer in the presently proposed method and system is used to gain advantage.

Secondly, the method and system are suitable for time-lapse monitoring. As the seismic source is buried below the fast layer, the method and system are insensitive to, or at least much less sensitive to, changes in the overburden that occur above the fast layer, than if the seismic source would be at the surface or shallowly buried above the fast layer (within e.g. a few tens of meters from the surface). Moreover, the proposed method and system allow for employment of a repeatable source, which may be weak compared to a seismic source that is based on, for instance, explosives.

Such factors are particularly beneficial for time-lapse monitoring (in some cases referred to as 4D monitoring) of the target layer. The relevant CR reflections (e.g. CR target reflections) are not the first arrivals at the one or more receivers, and other events may potentially overlap with signals caused by the relevant CR (target) reflections. This is referred to as source-generated noise. Changes in CR target reflections are more easily recognized in the signals if the noise is repeatable over time.

Thirdly, as the CR wave gradually emanates from the fast layer at every point between the seismic source and the at least one receiver, at source-receiver offsets larger than a critical offset between the source an any receiver the receiver can record a reflected CR wave signal. Thus provided the source is located at a larger than a critical offset there is flexibility to choose the location where the source can be positioned. This provides flexibility to minimize any adverse footprint effects at the earth surface.

Due to the lateral spreading of the downwardly emanating waves, a whole seismic line can be established with only one seismic source at a fixed offset relative to the at least one receiver. As the CR wave emanates downwardly into the slow layer under a fixed emanating angle that depends on the difference and/or contrast in seismic velocities between the fast layer and the slow layer, the amount of seismic energy contributing to the signal is relatively high. If the one or more receivers are spatially distributed below the fast layer along a length of the borehole above the reflecting layer, a 2D profile can be made using a single source at a fixed location.

A 3D profile can be made by acquiring seismic signals with the one or more receivers using waves from seismic sources located at different compass angles relative to the one or more receivers. In order to benefit from full illumination of all of the receivers, the source-receiver offset should preferably be sufficiently large (exceeding the critical offset). The critical offset will generally be dependent on the critical angle and the emanating angle, as well as the depth differential between the reflector and the receiver and on the depth differential between the reflector and the fast layer. It is estimated that a critical offset will typically exceed 600 m, so that preferably the source is laterally displaced from the one or more receivers by more than 600 m, more preferably by more than 1.1 km.

A seismic image of the multi-layered subsurface formation may be created, using the at least one reflected CR wave that has been isolated from the signals. Instead of such seismic image, or in addition to such seismic image, an event attribute may be derived based on the at least one reflected CR wave. The seismic image and/or the event attribute is/are outputted, suitably via an output device. Suitable output devices include a monitor, a screen, a plotter, or a printer.

The at least one reflected CR wave from which the seismic profile or image is created may comprise a critically reflected wave. Such critically reflected wave may be formed if for instance an intermediate layer in the overburden (or indeed the reservoir rock itself) captures the down-going CR wave.

As indicated above, the system and method are suitable for employing a seismic source that is repeatable. Piezo-electric vibrator sources and sparker sources and are considered to be examples of repeatable seismic sources.

For example, the seismic source may be the same commercially available piezoelectric vibrator sources as used by CGG Veritas for their SeisMovie™ reservoir monitoring solution. An example of a suitable repeatable source is described in US pre-grant publication Nr. 2014/0086012. Such repeatable source may be permanently installed in the subsurface, or repeatedly placed in existing boreholes which are retained to assure repeatability of the source location.

Another example is the down-hole sparker source. Information about the down-hole sparker source may be found in numerous public sources. A non-limiting list of examples includes the following references: Baria, R. et al. “Further development of a high-frequency seismic source for use in boreholes” in Geophysical Prospecting, Vol. 37, pp. 31-52 (1989); Rechtien, R. D. et al., “A high-frequency sparker source for the borehole environment: Geophysics, Vol. 58, pp. 660-669 (1993); and W. Heigl et al., “Development of a downhole sparker source with adjustable frequencies”, SEG Annual Meeting 2012 Expanded Abstracts. Down-hole sparker sources have been reported to have a time-repeatability of about 50 microseconds, or less than 100 microseconds.

Another repeatable downhole source contemplated for use in this invention is the downhole seismic source promoted by Schlumberger under the trade mark Z-Trac, originally proposed for cross-well imaging. Reference is made to an article (IPTC-16870-MS) with the title “Next Generation Borehole Seismic: Dual-Wavefield Vibrator System” as published in the International Petroleum Technology Conference, 26-28 Mar. 2013 by A. Nalonnil et al., and a patent description in US pre-grant publication No. 2014/0328139. This source produces both direct compressional waves and direct shear waves.

The seismic source is preferably positioned within a distance of less than (about) 80 m, preferably within a distance of less than 60 m, removed from the fast layer bottom interface. The closer that the seismic source can be positioned to the fast layer bottom interface the wider the angle of seismic waves radiated from the source that is within a critical angle determined by the fast layer/slow layer seismic contrast and thus contributing to the CR wave. However, the seismic source is preferably positioned not closer than (about) 30 meters to the fast layer bottom interface, in order to avoid and/or reduce influence of so-called near-field effects in the interaction between the seismic waves being emitted from the source and the fast layer.

The source may be positioned within a borehole extending to below the fast layer. The borehole may be oriented in any borehole direction. For example, the borehole may be oriented vertically, horizontally, or deviated (slanted, inclined). Preferably the source is oriented with reference to the fast layer bottom interface such that a main lobe of an irradiation pattern excited by the source is within the critical angle at the fast layer bottom interface. In case of broadside emitting source, this may be accomplished by selecting a deviated borehole.

The one or more receivers may be arranged in a borehole extending to below the fast layer. The borehole may be oriented in any borehole direction. For example, the borehole may be oriented vertically, horizontally, or deviated. If desired the receivers may be positioned in a side-tracked well or in both a main borehole and a side-tracked section.

Broadside sensitivity compared to the borehole direction may be required, depending on the dominant direction from which reflected CR waves arrive at the one or more receivers. Typically, broadside sensitivity is required in deviated boreholes that deviate away from the seismic source.

The one or more receivers may be provided in the form of an array comprising a plurality of discrete receivers such as geophones, or in the form of a single distributed sensor such as a fiber optic cable. The latter is sometimes referred to as distributed acoustic sensing (DAS) by a fiber optic cable. Reference is made to an article by Albena Mateeva et al. in Geophysical Prospecting, Vol. 62, pp. 679-692 (2014) with the title “Distributed acoustic sensing for reservoir monitoring with vertical seismic profiling”. As described in this article, broadside sensitivity may be achieved in various ways, including helically winding of a fiber optic DAS cable. The article is incorporated herein by reference.

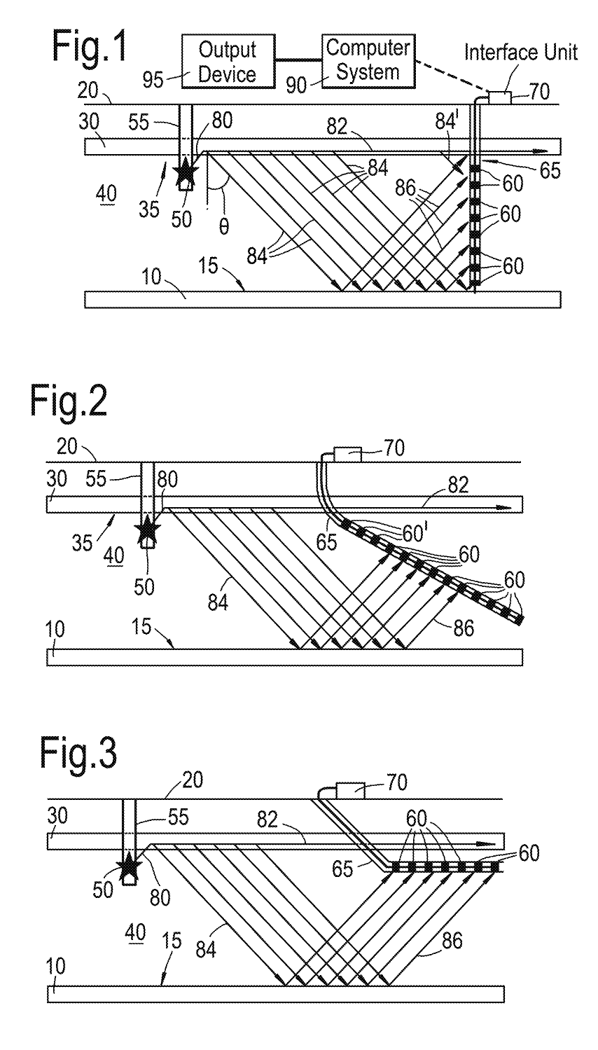

FIG. 1 schematically illustrates a first embodiment of the method and system of the present invention in a cross sectional view of a multi-layered subsurface formation model. The formation model comprises a target layer 10, here represented as a soft reservoir layer associated with a reservoir rock layer. Between the target layer 10 and the surface 20 there is an overburden. The overburden comprises a fast layer 30 buried below the earth surface 20 and interfacing with a slow layer 40 below the fast layer 30. The interface between the fast layer 30 and the slow layer below it will be referred to as the fast layer bottom interface 35.

At the top of the target layer 10 there is a target interface 15 between the target layer 10 and the overburden. In the present example, the target interface 15 will be employed as reflecting interface for reflecting critically refracted waves 84. However, in general any reflecting geological interface, such an interface formed by a geological layer below the overburden, can be used to infer relevant information concerning the target layer 10.

Although operation outside the given depth range is possible, it is envisaged that the present invention is particularly beneficial in situations where the fast layer 30 is located at a depth of less than for example 400 m or 500 m below the earth surface 20 (i.e. a fast layer bottom interface 35 between the fast layer 30 and the slow layer 40 is less than 400 m or 500 m below the earth surface 20). The less deep the fast layer bottom interface 35 is, the more room there is for positioning the one or more receivers between the fast layer bottom interface 35 and relevant reflecting interfaces below. The further away receivers can be positioned away from the reflecting interface, the further away from the receiver bore hole the multi-layered subsurface formation can be probed by the proposed system and method. Preferably, the entire fast layer 30 is within a depth range of between 10 m and 500 m, more preferably between 10 m and 400 m, and most preferably between 10 m and 200 m, below the earth surface 20.

A seismic source 50 is positioned below the fast layer bottom interface 35, within the slow layer 40. Suitably, the seismic source is positioned within a distance of 80 m (preferably within 50 m) from the fast layer bottom interface 35. Suitably the seismic source is confined within a borehole 55. The source borehole 55 may be vertical, inclined or deviated. For instance, the seismic source 50 may be located in a non-vertical section of the borehole 55, to optimize source orientation with respect to the fast layer 30 to enhance excitation of CR waves towards receiver borehole 65. The source may be permanently installed in the subsurface, or repeatedly placed in an existing borehole. In either case, the seismic source 50 is preferably a repeatable seismic source.

Receivers 60 are spatially distributed along a length of a borehole 65, below the fast layer 30 and above the reflecting layer 10. The borehole 65 is laterally displaced from the seismic source 50. The receivers 60 are represented here as an array comprising a plurality of discrete receivers such as geophones. However, it may be provided in the form of a single distributed acoustic sensor such as a fiber optic DAS cable.

A receiver interface unit 70 is arranged at the surface 20, and in communication with the receivers 60 to collect and process signals from the receivers 60. The interface unit 70 may sometimes be referred to as interrogator unit, particularly where the one or more receivers are embodied in the form of a fiber optic DAS cable. The receiver interface unit 70 may be in communication with a computer device 90. Suitably, an output device is functionally coupled to the computer device, for outputting the seismic profile. Examples of output devices include, but are not limited to, a monitor, a screen, a plotter, a printer, and/or combinations thereof.

The seismic source 50 and the receivers 60 can be used to provide a set of signals. The set of signals can be obtained by transmitting a seismic wave 80 from seismic source 50. As the fast layer 30 has a higher seismic velocity than the slow layer 40 in which the seismic source 50 is positioned, a certain portion of the seismic energy is emitted from the seismic source at an angle (measured with respect to a perpendicular direction from the fast layer bottom interface 35) within the critical angle for a CR wave 82 to be excited at the fast layer bottom interface 35. The CR wave 82 propagates along the fast layer bottom interface 35, and as the CR wave 82 propagates along the fast layer bottom interface 35 the CR waves gradually emanate downwardly into the slow layer 40 at a fixed emanating angle θ.

Suitably the emanating angle θ is defined as the angle between the propagation direction of the emanating wave 84 and a perpendicular of the fast layer bottom interface 35. A multiplicity of emanating waves may exist depending on whether the CR wave is a shear wave (S-wave) or a compressional wave (P-wave) and whether the downward emanating wave is a shear wave (S-wave) or a compressional wave (P-wave). All combinations are possible, each having a unique emanating angle. P-waves and S-waves may be sensitive to different properties of the formations that they propagate in, and hence it may be interesting to isolate signals originating from S-waves in addition to signals originating from P-waves. However, as their emanating angles differ mutually, it should be taken into account that the signals do not reflect the same area of illumination. Particularly downwardly emanating S-waves are expected to provide valuable information about the multi-layered subsurface formation.

The emanating waves 84 propagate downwardly and reflect off of interfaces of neighboring subsurface layers. Amongst the reflecting interfaces is the target interface 15, and (target) reflected CR waves 86 ultimately reach the receivers 60. Each emanating CR wave 84 is a down-going wave and each reflected CR wave 86 is an up-going wave.

First, an original set of signals containing contributions from all waves that reach the receivers 60 in response to the seismic wave 80 is recorded. The contribution to the signals of at least one reflected CR wave 86 is isolated. Isolation of reflected CR waves may involve processing including for instance up/down-going separation. Various techniques and combinations of techniques are known to the person skilled in the art for up-down separation of seismic waves. Up/down-going separation can be facilitated by having an array of receivers having at least a vertical separation, and/or multiple types of receivers or multicomponent receivers such as a 3-component geophone/accelerometer or a fiber-optic DAS cable that is sensitive in multiple, preferably three, components. In some cases information of an omnidirectional pressure sensor may have to be used in combination. Isolation of reflected CR waves may further involve modeling to determine for instance expected arrival times and subsequently considering a window of arrival times. Examples of three-component sensitive fiber optic DAS cables can be found in e.g. WO2014/022346 and US2014/0345388, which are both incorporated herein by reference.

A seismic image of the multi-layered subsurface formation may be created using the contributions in the signals of the reflected CR waves 86 and/or an event attribute may be derived based on the reflected CR waves 86. The seismic image may be created by and/or the event attribute derived by the computer system 90. Ultimately the seismic image and/or the event attribute may be outputted on a suitable output device 95.

An entire 2D seismic image can be created using a single seismic source 50 that is laterally displaced from the receivers 60, without a need to relocate or move the seismic source 50 to establish different offsets. Clearly, by spanning the one or more receivers as much as possible between the fast layer bottom interface 35 and the reflecting interface (such as target interface 15) the area of illumination can be maximized. A 3D image can be created by acquiring seismic signals with the receivers from seismic sources located at different compass angles relative to the receivers and at sufficiently large offset with respect to each of the one or more receivers to ensure full illumination. However, a single source placement per compass angle suffices. Thus a ring of seismic shots at relatively large offset would suffice rather than a full grid with varying offset. The ring does not have to be circular.

The system and method can be used for time-lapse surveying of the target layer 10. A repeat set of signals may be obtained after lapse of a certain amount of time, for instance after one or more weeks, months or even years of time, in the same way as the original set of signals. Information may then be inferred about a change in the target layer 10 based on a comparison between (target) reflected CR waves from the repeat set of signals and from the original set of signals. Change in the target layer may for instance be a result of one or more from the group consisting of: steam injection, pressure change, fracturing, temperature change, oil saturation change, gas saturation change, and injection of chemicals within the target layer 10. Particularly in the context of time-lapse surveying the use of derived event attributes, such as target event attributes, may provide valuable insights into what is going on in the multi-layered subsurface formation. The information thus obtained may prompt changes in how the multi-layered subsurface formation containing reservoir rock formation is being developed in order to achieve targets, such as hydrocarbon production targets or CO₂ storage targets.

The present method and system are suited for such time-lapse survey as the location of the seismic source within the borehole is repeatable and moreover as the method allows for the use of presently commercially available repeatable sources which tend to be weak but provide a repeatable signature. Furthermore, changes in the shallow overburden above the fast layer 30 do not contribute to changes in the seismic signals.

These considerations are relevant as with the present system and method the relevant CR reflections (e.g. CR target reflections) are not first arrivals at the receivers 60. Therefore signals associated with CR (target) reflections may be overlapped by other events (noise). The noise may be suppressed by signal processing in a similar way as is frequently done in vertical seismic profile signal processing, but in the present method and system the noise is repeatable if the overburden below the fast layer 30 is unchanged and the source is repeatable. In such cases noise can be suppressed by subtracting original and repeat data sets.

Changes in the fast layer 30 may be assessed by considering evaluating signals corresponding to direct CR wave responses. A direct CR wave 84′ is shown in FIG. 1 as example, which is a downward emanating CR wave that is not reflected prior to detection in the receiver. Preferably, such direct CR wave response is considered at the receiver that is closest to the fast layer 30 compared to the other receivers in order to be the least as possible influenced by the underlying slow layer 40.

Conversely, direct CR waves 84′ may be used for matching purposes if it can be assumed that the fast layer 30 has not changed over the time-lapse employed. Other arrivals of the overburden that are assumed not to have changed may also be employed for matching purposes.

FIGS. 2 and 3 schematically show embodiments wherein the borehole 65 in which the one or more receivers 60 are positioned are not vertical but slanted (FIG. 2) or horizontal (FIG. 3). The computer system 90 is not shown. It can be seen that in the case of the slanted borehole (FIG. 2) the target reflected CR waves 86 could be propagating perpendicular or near perpendicular to the direction in which the borehole is oriented. Particularly in this case, broadside sensitivity of the receivers 60 is desired which in the case of a fiber optic DAS cable can be achieved by helically winding the fiber around a core. The core may then be oriented in the same direction as the borehole.

Furthermore, FIG. 2 illustrates an example whereby the source is too close to the one or more receivers to accomplish full illumination. It can be seen that the receivers 60′ that are closest to the fast layer bottom interface 35 cannot be reached by any reflected CR wave. Therefore, in the situation as depicted in FIG. 2 the seismic source 50 is located at an offset that is smaller than the critical offset. The source-receiver offset as shown in FIG. 1 is just larger than the critical offset as a small portion of the reflected CR waves illuminate the fast layer bottom interface 35 between the one or more receivers 60 and the source 50.

Suitably, the seismic velocity of the fast layer is at least 200 m/s, preferably at least 400 m/s, higher than that of the slow layer. In relative terms, the seismic velocity of the fast layer may be at least 10%, preferably at least 25%, higher than that of the slow layer. The larger the difference and/or contrast in seismic velocity, the easier it is to excite a refraction at the fast layer bottom interface and have it illuminate the desired reflecting interface. With a larger contrast, the emanating angle of the down-going refraction will be smaller (i.e. steeper, closer to vertical), and as a result (1) the down-going CR wave is less likely to be refracted again (up) by a deeper fast layer before reaching a useful reflecting interface; and (2) a smaller source-receiver offset can be used (allowing weaker seismic sources, as well as fewer sources needed to encircle the receivers to achieve full areal illumination).

Finally it is remarked that seismic velocities generally increase with depth. Typical seismic velocities at a few kilometers depth might be in the range of from about 2500 to about 3500 m/s. At such depths, a layer having a seismic velocity in the range of from about 4000 to about 5000 m/s would be considered to be a fast layer. But in shallow subsurface (up to a few hundred meters depth, such as up to 400 m or up to 500 m depth), where the proposed invention is the most relevant, typical seismic velocities are below 2000 m/s. At such depths, a layer having a seismic velocity of 2000 m/s or higher that is embedded in a surrounding formation wherein the seismic velocity is lower than 2000 m/s is considered to constitute a fast layer. However, in practice there is great variability. In some places the average seismic velocity in the shallow subsurface may be about 3000 m/s, in which case the seismic velocity in a fast layer would need to be faster, such as 3500 m/s or more.

The person skilled in the art will understand that the present invention can be carried out in many various ways without departing from the scope of the appended claims.

1. A method of creating a seismic profile of a multi-layered subsurface formation below an earth surface, said subsurface formation comprising a reservoir rock layer, such as a hydrocarbon reservoir rock layer, covered by an overburden that comprises a slow layer covered by a fast layer, wherein the slow layer is adjacent to the fast layer and separated from the fast layer by a fast layer bottom interface, said method comprising steps:
a) providing a set of signals obtained by:
transmitting a seismic wave from a seismic source that is positioned below the fast layer;
receiving an original set of signals emanating from the multi-layered subsurface formation in response to the seismic wave with one or more receivers arranged within a borehole spatially distributed along a length of the borehole, wherein the one or more receivers are located below the fast layer, whereby said original set of signals comprises received signals;
b) isolating from the received signals at least one reflected critically refracted wave that has traveled along the fast layer bottom interface as a critically refracted (CR) wave, emanated downwardly into the slow layer as a downwardly emanated CR wave, and reflected off of a reflecting interface that is located below the one or more receivers; and
c) creating a seismic profile of the multi-layered subsurface formation using the at least one reflected CR wave.

2. The method of claim 1, further comprising step:
d) outputting the seismic profile to an output device.

3. The method of claim 1, further comprising:
e) repeating steps a) and b) in a time-lapse mode so as to obtain at least a repeat set of signals instead of the original set of signals; and
f) inferring information about a change in the multi-layered subsurface formation based on a comparison between reflected CR waves from the repeat set of signals and from the original set of signals.

4. The method of claim 3, wherein the change in the multi-layered subsurface formation is a result of one or more from the group consisting of: steam injection, change in pressure, fracturing, temperature change, oil saturation change, gas saturation change, and injection of chemicals within the multi-layered subsurface formation.

5. (canceled)

6. The method of claim 1, wherein at least the original set of signals comprises received signals from a plurality of locations along the length of the borehole.

7. The method of claim 1, wherein the one or more receivers consist of a fiber optic distributed acoustic sensing cable coupled to an interrogator unit located at the surface.

8. The method of claim 1, wherein the seismic source is a repeatable source.

9. The method of claim 1, wherein the fast layer has a higher seismic velocity than the slow layer.

10. The method of claim 8, wherein the seismic velocity of the fast layer is at least 10% higher than that of the slow layer.

11. The method of claim 9, wherein the seismic velocity of the fast layer is at least 200 m/s higher than that of the slow layer.

12. The method of claim 1, wherein the seismic source is positioned within the slow layer.

13. The method of claim 1, wherein the seismic source is positioned within at most 80 m removed from the fast layer bottom interface, and/or not closer than 30 vertical meters to the fast layer bottom interface.

14. The method of claim 1, wherein the fast layer is located at a depth of less than 500 m below the earth surface.

15. The method of claim 1, wherein the downwardly emanated CR wave is a shear wave.

16. The method of claim 1, wherein the at least one reflected CR wave comprises a critically reflected wave.

17. The method of claim 1, wherein creating said seismic profile comprises creating a seismic image of the multi-layered subsurface formation using the at least one reflected CR wave and/or deriving an event attribute based on the at least one reflected CR wave.

18. A system for creating a seismic profile of a multi-layered subsurface formation below an earth surface, said subsurface formation comprising a reservoir rock layer, such as a hydrocarbon reservoir rock layer, covered by an overburden that comprises a slow layer covered by a fast layer, wherein the slow layer is adjacent to the fast layer and separated from the fast layer by a fast layer bottom interface, said system comprising:
a seismic source that is positioned below the fast layer bottom interface;
one or more receivers located below the fast layer and arranged within a borehole spatially distributed along a length of the borehole;
a receiver interface unit arranged at the surface and in communication with the one or more receivers to collect and process signals from the one or more receivers; and
a computer device for creating a seismic profile of the multi-layered subsurface formation using at least one reflected critically refracted wave that has been isolated from the signals.

19. The system of claim 18, further comprising an output device is functionally coupled to the computer device, for outputting the seismic profile.

20. (canceled)

21. The system of claim 18, wherein the one or more receivers consist of a fiber optic distributed acoustic sensing cable coupled to an interrogator unit located at the surface.

22. The system of claim 18, wherein the seismic source is a repeatable source.

23. The system of claim 18, wherein the seismic source is positioned within the slow layer.
